(19) United States
(12) Patent Application Publication
(10) Pub. No.: US 2024/0321320 A1
(43) Pub. Date: Sep. 26, 2024

(54) HARMONIZING SYSTEM FOR OPTIMIZING SOUND IN CONTENT

(71) Applicant: KINT Inc., Seoul (KR)

(72) Inventor: Philip HA, Seoul (KR)

(73) Assignee: KINT Inc., Seoul (KR)

(21) Appl. No.: 18/610,776

(22) Filed: Mar. 20, 2024

Related U.S. Application Data
(60) Provisional application No. 63/453,482, filed on Mar. 21, 2023.

(51) Int. Cl. G11B 27/10; G11B 27/031

(52) U.S. Cl. CPC G11B 27/10; G11B 27/031

(57) ABSTRACT

This present disclosure is a harmonizing system for optimizing sound in content, and the harmonizing system comprises a user terminal configured to transmit and receive a video content containing sound information, and the user terminal includes a display unit configured to display the video content; a speaker configured to load the sound information and output sound; and a user input unit configured for user input.

### CROSS REFERENCE SECTION

This application claims the priority benefit of U.S. Provisional Application 63/453,482, filed Mar. 21, 2023, the entire content of which is hereby incorporated by reference herein.

### BACKGROUND

### Field of the Invention

The present disclosure relates to a harmonizing system for optimizing sound in content and more specifically to the harmonizing system for optimizing the sound in the content, which harmonizes the sound of the content by synchronizing the audio with the video, after optimizing an audio separated from a video in the content based on an artificial intelligence model.

### Description of the Related Art

Existing systems for optimizing sound in content have largely been limited to simply adjusting a volume of audio tracks, removing a basic noise, or adding simple sound effects. In addition, these systems have enabled a replay of video content and an adjustment of basic sound information through a display unit, a speaker, a user input unit, etc. of a user terminal. However, a complexity of various sound information and a need for detailed adjustment included in the video content haven't sufficiently been satisfied.

In addition, even if a request for harmonizing a specific video content of a plurality of video contents is received from a user, there has been no process to provide an improved audio quality by effectively analyzing a various sound information included in the video content and applying an optimized sound mastering preset. Because of this, there has been a limitation in improving an audio quality experienced by a user. Especially, there has been a problem not to meet requirements in professional user environments to require an advanced audio processing.

### SUMMARY

It is one of objects of the present disclosure to solve the above-mentioned problems. Various aspects of the present disclosure are directed to providing a harmonizing system to effectively process a complexity and diversity of the sound information in the video content by applying an advanced audio processing technology in order to dramatically improve a user' experience, by providing the user with a harmonic content including an improved audio quality, while analyzing sound information in video content received from a user terminal by using an artificial intelligence model and applying an optimal sound mastering preset based on this.

According to an embodiment of the present disclosure, a harmonizing system for optimizing sound in content, comprising: a user terminal configured to transmit and receive video content containing the sound information, the user terminal including: a display unit configured to display the video content; a speaker configured to load the sound information and output sound; and a user input unit configured for user input.

The harmonizing system further comprises a server network-connected to the user terminal, the server concluding: a communication unit; a storage unit; and a processor configured: to display at least one platform screen of a website that provides an execution of the artificial intelligence model or an application through a predetermined API, when receiving a request for a sound harmonization based on an artificial intelligence model from the user terminal, to store a first sound data that includes the first waveform information in the storage unit by identifying a first waveform information that includes a frequency range and volume level based on a first sound information included in the first video content, when receiving a first video content of a plurality of video contents from the user terminal through the platform, to generate a second sound data that applies a first sound mastering preset corresponding to the first waveform information of a plurality of sound mastering presets that are previously stored, based on the first sound data, in the storage unit, and to transmit a first harmonic content that the second sound data is synchronized with the first video content to the user terminal.

The processor is further configured: to identify a first video information including conversation contents, natural environments, and background sounds, which are included in the first video content, based on the first sound data and a first video data of the first video content; to display a plurality of purpose lists for production purposes of the first video content on the display unit, corresponding to the first video information identified; to generate a third sound data that the first noise is removed and identify a sound data not corresponding to the first purpose of the first video information as a first noise, when receiving a user input that a first purpose of the plurality of purpose lists is selected from the user terminal; to adjust a sound to be clear in the main frequency range by setting a main frequency range in the third sound data and adjusting EQ, allowing an up-mix processing to be reflected in the third sound data when the first purpose corresponds an aspect that it is realized in a first space size predetermined and allowing a downmix processing to be reflected in the third sound data when the first purpose corresponds an aspect that it is realized in a size smaller than a second space size predetermined; and to transmit the second harmonic content to the user terminal by generating a fourth sound data that at least one of the up-mix processing or downmix processing is reflected in the third sound data and generating a second harmonic content that the fourth sound data is synchronized with the first video content.

### BRIEF DESCRIPTION OF DRAWINGS

FIG. 1 is a diagram showing a schematic configuration of a harmonizing system for optimizing sound in content according to an embodiment of the present disclosure.

FIG. 2 is a diagram showing a specific configuration of the harmonizing system for optimizing sound in content according to the embodiment of the present disclosure.

FIG. 3 is a diagram showing an algorithm for operating the harmonizing system for optimizing sound in content according to the embodiment of the present disclosure.

### DETAILED DESCRIPTION

Hereinafter, embodiments of the present disclosure will be described in detail with reference to the accompanying drawings. In the drawings, the same reference numbers or symbols refer to components that perform substantially the same function, and size of each component in the drawings may be exaggerated for clarity and convenience of explanation. However, a technical idea of the present disclosure and its core configuration and operation are not limited to a configuration or operation described in the following embodiments. In describing the present disclosure, if it is determined that a detailed description of a known technology or configuration related to the present disclosure may unnecessarily obscure a gist of the present invention, the detailed description will be omitted.

In the embodiments of the present disclosure, terms containing ordinal numbers, such as first, second, etc., are used only for a purpose of distinguishing one element from another element, and singular expressions include plural expressions unless the context clearly indicates otherwise. Additionally, in the embodiments of the present disclosure, it should be understood that terms such as ‘consist’, ‘include’, ‘have’, etc. do not preclude a possibility of presence or addition of one or more other features, numbers, steps, operations, components, parts, or a combination thereof. Additionally, in the embodiments of the present disclosure, a ‘module’ or ‘unit’ performs at least one function or operation, may be implemented as a hardware or a software, or as a combination of the hardware and the software, and may be integrated into at least one module and implemented with at least one processor. Additionally, in the embodiments of the present disclosure, at least one of a plurality of elements refers to not only all of the plurality of elements, but also each one or all of a combination thereof excluding the rest of the plurality of elements. Additionally, “Configured (or set) to”, for example, may be used interchangeably with “suitable for,” “having the capacity to,” “designed to,” “˜ “adapted to,” “made to,” or “capable of” depending on a situation. “Configured (or set to)” may not necessarily refers to “specifically designed to” in terms of hardware. Instead, in some situation, the expression, “device configured to”, may refers to that the device is “capable of” to work with other devices or components. For example, “processor configured (or set) to perform A, B, and C”, the phrase, may refers to a general-purpose processor (e.g., CPU or application processor) capable of performing the corresponding operation by executing one or more software programs stored in a dedicated processor (e.g., embedded processor) or a memory device for performing the corresponding operation.

Hereinafter, the preferred embodiments of the present disclosure will be described in detail with reference to the drawings. This is intended to provide a detailed description so that a person with ordinary knowledge in a technical field to which the present disclosure pertains may easily implement an invention. For this reason, it should be noted that a technical idea and scope of the present disclosure are not limited.

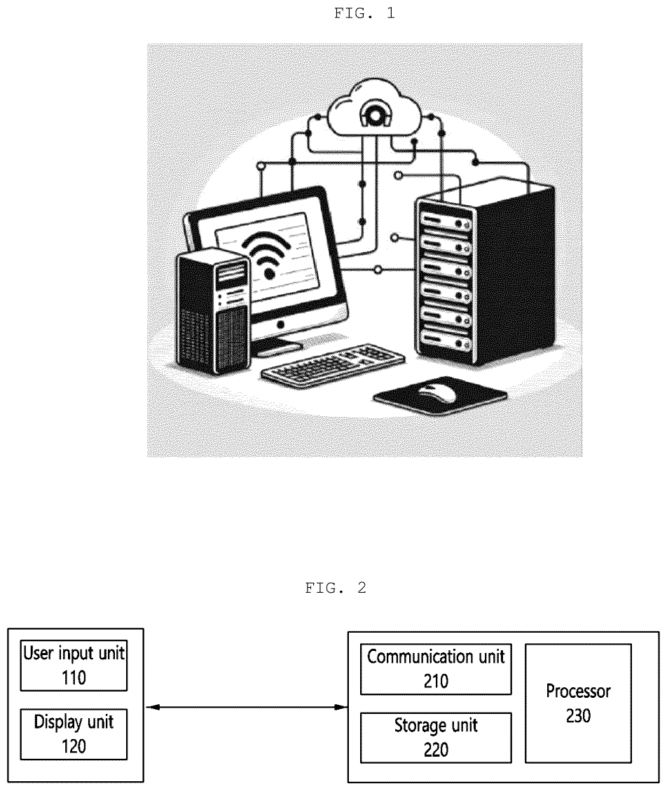

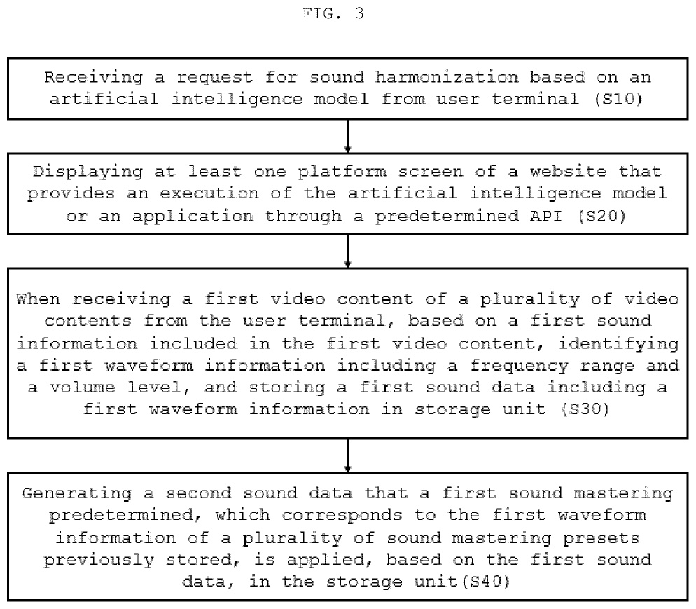

FIG. 1 is a diagram showing a schematic configuration of a harmonizing system for optimizing sound in content according to an embodiment of the present disclosure, FIG. 2 is a diagram showing a specific configuration of the harmonizing system for optimizing sound in content according to the embodiment of the present disclosure, and FIG. 3 is a diagram showing an algorithm for operating the harmonizing system for optimizing sound in content according to the embodiment of the present disclosure.

Referring to FIGS. 1, 2, and 3, according to the embodiments of the present disclosure, the harmonizing system for optimizing sound in content includes a user terminal configured to transmit and receive video content including sound information.

According to an embodiment of the present disclosure, a user terminal (100), for example, includes a distributed computing which includes personal computers, server computers, handheld or laptop devices, mobile devices (mobile phones, PDAs, media players, etc.), multiprocessor systems, consumer electronics, minicomputers, mainframe computers, any of foregoing systems, or devices, and an edge computing environment, etc. where data is processed around where the data is generated rather than on a central server. This above composition is also not limited to what is described above.

The user terminal (100) may include at least one processor and memory. Here, the processor may include, for example, a central processing unit (CPU), a graphics processing unit (GPU), a microprocessor, an application specific integrated circuit (ASIC), a field programmable gate array (FPGA), etc., and may include a plurality of cores.

The memory may be a volatile memory (e.g., RAM, etc.), a non-volatile memory (e.g., ROM, flash memory, etc.), or a combination thereof. Additionally, the user terminal (100) may include an additional storage. Even if the storage includes a magnetic storage, an optical storage, etc., it is not limited to these. Computer-readable instructions may be stored for implementing one or more embodiments disclosed herein in the storage. Other computer-readable instructions may also be stored for implementing operating systems, application programs, etc. The computer-readable instructions stored in the storage may be loaded into the memory in order to be executed by the processor.

Additionally, the user terminal (100) may include a user input unit (110) and an output device. The user input unit (110) may include, for example, a keyboard, a mouse, a pen, a voice input device, a touch input device, an infrared camera, a video input device, or any other input device, etc. The output device may also include, for example, one or more displays, a speaker, a printer, or any other output device, etc. A computing device may also use an input device or output device provided in another computing device as the user input unit (110) or the output device. Additionally, the computing device may include a communication module that allows the computing device to communicate with other devices. Here, the communication module may include other interfaces in order to connect a modem, a network interface card (NIC), an integrated network interface, a radio frequency transmitter/receiver, an infrared port, a USB connection, or a computing device to another computing device. The communication module may include a wired or a wireless connection.

Each component of the user terminal (100) may be connected by various interconnections (e.g., a peripheral component interconnection (PCI), a USB, a firmware (IEEE 1394), an optical bus structure, etc.), such as buses, etc., and may also be interconnected by a network. As used in the present specification, terms such as “component”, “system”, etc. generally refer to computer-related entities that are a hardware, a software, a combination of the hardware and the software, or an executing software.

According to the embodiment of the present disclosure, the user terminal (100) may include a display unit (120), and a method of implementing a display is not limited, and, for example, the display unit may be implemented in various display methods of a Liquid Crystal, a Plasma, a Light-Emitting Diode, an Organic Light—an Emitting Diode, a Surface-Conduction Electron-Emitter, a Carbon Nano-Tube), a Nano-Crystal, etc. The display unit (120), in case of a liquid crystal method, includes a liquid crystal display panel, a backlight unit which supplies light to the liquid crystal display panel, and a panel driver, etc. which drives the liquid crystal display panel. Meanwhile, the display unit (120) may be implemented as an OLED panel which is a self-luminous device without the backlight unit.

According to an embodiment of the present disclosure, the content in the harmonizing system for optimizing sound in content includes all forms of an audio and video information stored or transmitted in digital format, and these contents include movies, music videos, documentaries, podcasts, interviews, recorded lectures, etc., all of which are classified as digital media that the user mat watch or listen to.

For example, a live video of a performance filmed outdoors may include not only a smooth audio track of the performance, but also various audio elements, such as an audience reaction, an environmental noise, etc. Meanwhile, according to the present disclosure, sound optimization in video may be aimed at ensuring that a main audio of the performance is clearly transmitted while appropriately including cheers of audience.

As an embodiment, in case of an interview video, it is important to clearly convey a conversation between an interviewer and an interviewee, and Noises or other distractions to occur in a background should be minimized because they may prevent a user from watching the content. A harmonizing system of the present disclosure automatically identifies important parts of conversation by utilizing intelligence, and is implemented to contribute to improving an understanding of content and an overall viewing experience by both emphasizing this and performing audio processing to effectively reduce noise, and detailed descriptions related to this will be provided later.

According to an embodiment of the present disclosures, in the harmonizing system for optimizing sound in content, sound optimization is a process to provide a better audio experience to the user by analyzing, adjusting, and improving sound information derived from various audio sources. In this process, reducing a background noise, increasing a clarity of dialogue and key sound events, and improving a stereoscopic effect and space-sense of sound may be included. In other words, the sound optimization aims at enabling the user to better understand and appreciate content.

Meanwhile, according to the present disclosure, the sound optimization is performed based on sound information of original content provided from the user terminal and may be performed using artificial intelligence technologies, sound analysis algorithms, and various audio processing technologies. This process may also be adjusted in various ways depending on the user's audio listening environment, a type and purpose of content, and an audio effect required for specific scenes or events.

In the present disclosure, the sound optimization focuses on maximizing the user's experience, ultimately contributes to improving overall quality of content, thereby enables the user to understand content more clearly, and may also increase the user's satisfaction by providing a richer and more vivid audio experience.

According to an embodiment of the present disclosure, a harmonizing in the harmonizing system for optimizing sound in content refers to adjusting balance and achieving harmony among various sound elements in audio source, which maximizes a quality of audio experienced by the user and aims at ensuring that key sound elements harmonize well with each other. The harmonizing may include a work to adjust a volume, a tone, a temporal position, etc. of all audio elements included in video content, such as a dialogue, a music, a background sound, a special effect sound, etc.

According to the present disclosure, the harmonizing adjusts a dynamic range of audio track and ensures that major audio elements may receive each appropriate attention. For example, when a dialogue is an important part in a movie or video, the harmonizing may be adjusted so that a background music or environmental sound may not overshadow the dialogue, or, conversely, be implemented so that other audio elements may appropriately play a complementary role, allowing the music, in scenes where a music is important, to come to a front.

In addition, in the present disclosure, the harmonizing may include a series of steps to adjust and optimize sound according to characteristics of a corresponding audio and purposes of content, starting with an analysis of an audio track received from the user terminal, which may be automated using artificial intelligence models or other audio processing algorithms, and an end result may be implemented to provide an improved audio experience for the user.

According to an embodiment of the present disclosure, sound information in the harmonizing system for optimizing sound in content refers to various types of audio data included in the content, and these audio data may include all sounds associated with video content, such as a dialogue, a music, a background sound, an environmental sound, a special effect sound, etc. The sound information includes data on various audio properties such as a frequency, a volume, a temporal arrangement, a stereoscopic effect, etc.

In the present disclosure, the sound information is collected from the user terminal for analysis, processing, and optimization, and then adjustments are made to provide a better audio experience to the user through a harmonizing process. Analysis of the sound information includes a frequency analysis, a volume level measurement, and an analysis of temporal characteristics of audio signals, and, based on this information, various elements of audio are harmoniously adjusted and optimized.

According to an embodiment of the present disclosure, video content in the harmonizing system for optimizing sound in content refers to video data filmed, edited, and stored in digital format, and the video content may include various types of videos, such as a movie, a documentary, an advertisement, a music a video, an educational material, a personal blog, a real-time streaming, etc. Since including not only visual images but also audio information such as a dialogue, a music, a background sound, etc., the video content may include providing both a visual and auditory information to the user.

According to an embodiment of the present disclosure, the user terminal includes a speaker which loads the sound information and outputs sound.

According to the present disclosure, the speaker is an electronic device which receives an audio signal and converts it into a sound, and the sound may be manufactured in various shapes and sizes. The speaker in the user terminal is also designed by considering a portability and an ease of use, and may be implemented to deliver an audio content clearly and richly to the user.

Meanwhile, according to the present disclosure, the speaker converts an electrical audio signal into a mechanical vibration, so it may vibrate air, and may include any device to output a sound by transmitting it as a sound wave.

In the present disclosure, the speaker of the user terminal is a means of providing the sound information optimized to the user through the harmonizing system, and may be implemented to improve the user's listening experience and contribute to increasing overall satisfaction with content by allowing the user to listen to a sound-optimized content.

According to an embodiment of the present disclosure, a server (200) includes a storage unit (220), a communication unit (210), and a processor (230).

According to an embodiment of the present disclosure, the communication unit (210) may communicate with the user terminal (100) or other external electronic devices, etc. in a wired or wireless communication method. Therefore, in addition to a connection unit including a connector or terminal for wired connection, the communication unit may be implemented in various other communication methods. For example, the communication unit may be configured to perform a communication by one or more of a Wi-Fi, a Bluetooth, a Zigbee, an infrared communication, a Radio Control, an Ultra-Wide Band (UWM), a Wireless USB, and a Near Field Communication (NFC). The communication unit (210) may include communication modules such as a Bluetooth Low Energy (BLE), a Serial Port Profile (SPP), a Wi-Fi Direct, an infrared communication, a Zigbee, a Near Field Communication (NFC), etc. Additionally, the communication unit (210) may be implemented in forms of a Device, a S/W module, a Circuit, a Chip, etc.

According to the embodiment of the present disclosure, the communication unit (210) may include various communication modules described above, which may include an IoT communication module having an IoT network for each communication company. The IoT communication module may refers to any IoT communication network in which a plurality of objects including the separate communication units (210) may be connected through a network and which enables services based on various platforms. When such IoT communication modules are used, a smoother communication network may be provided than a designated area.

According to an embodiment of the present disclosure, the storage unit (220) may receive information from the user terminal (100) through the communication unit (210), or receive and store it. Information of detailed items, etc. which manages a use of an application received by the processor (230) may also be received and stored. The storage unit (220) may store various data, according to a processing and a control of the processor (230) which will be described later. The storage unit (220) may be accessed by the processor (230), so that it may read, record, modify, delete, update data and so forth. The storage unit (220) may include a non-volatile memory such as a flash-memory, a hard-disc drive, a solid-state drive (SSD), etc. in order to preserve data to the server (200) regardless of whether or not system power is provided. Additionally, the storage unit (220) may include a volatile memory such as a buffer, a random-access memory (RAM), etc. for temporarily loading data processed by the processor (230).

According to an embodiment of the present disclosure, the processor (230) may perform a control so that various components of the server (200) may operate. The processor (230) may include at least one processor or CPU (Central Processing Unit) which executes a control program (or instructions) for performing such control operations, an inactive memory that the control program is installed, a volatile memory that at least a part of the installed control program is loaded, and a loaded control program. Additionally, such control programs may be stored even in other external electronic devices in addition to the server (200).

The control program may include program(s) implemented in a form of at least one of a BIOS, a device driver, an operating system, a firmware, a platform, and an application program (application). In an embodiment, the application program is pre-installed or stored in the server (200) when the server (200) is manufactured, or when used in the future, data of the application program may be received from outside and be installed on the server (200) based on the received data. The data of the application program may be downloaded from an external server, for example, such as an application market, but the data is not limited to this. Meanwhile, the processor (230) may be implemented in a form of a device, a S/W module, a circuit, a chip, etc., or a combination thereof.

According to an embodiment of the present disclosure, when receiving a request for a sound harmonizing based on an artificial intelligence model from the user terminal, the precessor may display at least one platform screen of a website to provide execution of the artificial intelligence model or an application through a predetermined API.

According to the embodiment of the present disclosure, when receiving the request for the sound harmonizing based on the intelligence model from the user terminal, the processor displays the at least one platform screen of the website to provide execution of the artificial intelligence model or the application through the predetermined API on the user terminal in order to process the request.

Meanwhile, according to the present disclosure, the platform screen is designed to allow the user to manage and adjust a sound harmonizing operation, and may be implemented to provide an interface so that the user may set and execute harmonizing parameters.

According to an embodiment of the present disclosure, the artificial intelligence model consists of an algorithm and a learning data necessary to perform an audio processing function, and may be implemented to recognize and analyze complex patterns of sound data based on machine learning, especially, the deep learning technology. In addition, according to the present disclosure, the artificial intelligence model learns audio characteristics, such as a frequency range, a volume, a timbre, etc. through a training data, and through this, the artificial intelligence model may be implemented to develop predictive models to analyze and improve audio tracks.

Meanwhile, according to the present disclosure, the artificial intelligence model may include deep learning architectures such as a convolutional neural network (CNN), a recurrent neural network (RNN), and a transformer. These models are also implemented to perform various tasks, such as capturing temporal and spatial characteristics of sound data, distinguishing a voice from a background noise, applying sound effects and so forth.

In the specific embodiment, the artificial intelligence model of the present disclosure is utilized to process sound data in video content provided by the user, such as automatically identifying and separating a dialogue, a music, and a background noise within movie clips uploaded by the user. Then, a harmonizing processing, which may include a noise removal, a volume balance adjustment, a sound quality improvement, etc., is performed on separated audio tracks.

According to an embodiment of the present disclosure, the website or predetermined API, which provides an execution of the artificial intelligence model, refers to an online platform that allows the user to access and utilize artificial intelligence-based sound processing services, and the website or API plays a role to provide an interface through which the user may upload video and audio content and may request a harmonizing processing for a corresponding content.

According to the embodiment of the present disclosure, the website may include a dashboard including a user-friendly graphical user interface (GUI), a section for uploading and managing files, and an analysis report area showing a processing result. The API provides the interface based on RESTFUL principles, allowing applications written in various programming languages to call services through a HTTP request.

In the specific practical embodiment, the website or API of the present disclosure may be utilized in various application programs to require a quality improvement of audio and video content, such as an online music production studio, a movie editing software, or a podcast production platform, and, for example, film-makers may upload their own movie clip through website and may request an audio harmonizing processing such as removing a background noise, improving a clarity of dialogue, and applying a sound effect. After the processing is complete, the film-makers downloads a synchronized video with an enhanced audio, which they may use in the final edit. Additionally, when utilizing the API, a video editing software may provide an integration with artificial intelligence harmonizing services so that the user may directly request an audio enhancement work and receive results inside a software.

According to an embodiment of the present disclosure, a platform consists of a digital interface that provides artificial intelligence-based sound processing functions, and may be implemented so that the user may upload a video and audio content, select, and apply a specific sound processing service. Additionally, the platform may be provided in a form of a web-based interface or mobile application, and may be implemented so that the user may access it anytime and anywhere, through an Internet connection.

In addition, according to the present disclosure, the platform includes a file upload module, a user request processing module, an audio analysis module, a sound processing module, a result preview module, and a download module. The user may also upload his or her own audio and video files through the file upload module. Additionally, the user request processing module manages and analyzes an corresponding request based on sound processing options selected by the user, and the audio analysis module determines necessary processing methods by extracting and analyzing sound information in uploaded files, and the sound processing module performs processes such as a noise removal, a volume adjustment, and a tone improvement, etc. according to an analyzed sound information, and the result preview and download module provides the user with preview of processed files, which may be implemented to download final files to the user who has obtained satisfactory results. Additionally, the platform of the present disclosure may be hosted on a cloud-based server, and may be implemented so that the user may easily access and use a service by visiting a website or using an app.

According to an embodiment of the present disclosure, when receiving a first video content of a plurality of video contents from the user terminal through the platform, the processor may identify a first waveform information including a frequency range and volume level based on a first sound information included in the first video content and may store a first sound data including the first waveform information in the storage unit.

More specifically, according to the embodiment of the present disclosure, after receiving the first video content uploaded from the user terminal through the server platform, the processor extracts an audio track, namely, the first sound information, included in video, and at this time, the processor analyzes a frequency range and volume level of this sound information to identify the first waveform information, which may be performed by utilizing a digital signal processing (DSP) technology for sound information. The first waveform information identified, which becomes a basis for subsequent sound processing operations, is stored in the server's storage.

In the specific embodiment, when the user uploads a live concert recording video, the live concert recording video uploaded by the user includes a complex sound information, such as audience cheers, musical instrument sounds, singers' voices, etc. At this time, the processor separates this complex sound information and identifies a frequency range and volume of each element. For example, the singer's voice shows its strongest signal in a mid-frequency range, the instrumental sounds are distributed over a wider frequency range, and the sound of the audience cheers may be identified primarily in a high-frequency range and a low volume level. The processor may also store waveform information obtained through analyses in the storage unit.

Meanwhile, according to an embodiment of the present disclosure, in addition to extracting sound information, a still image or dynamic image included in the first video content may be extracted according to the user's request, and when receiving a request to change a background screen for the still image or dynamic image included in the first video content received from the user terminal, the processor may change and display the still image or dynamic image included in the first video content on the display unit by reflecting a background screen change corresponding to a change request through an image conversion data set previously stored in the storage unit. Additionally, when there is a continuous request to change a background screen from the user terminal due to feedback, the processor may sequentially reflect and provide this to the user.

For example, when receiving a request to change a background screen of a specific still image or dynamic image in video content from the user terminal, the processor performs a requested background change operation by using a predefined image conversion dataset, and, at this time, the image conversion data set previously stored in the storage unit includes a plurality of background screen options, which may be composed of various categories, such as a natural scenery, an abstract graphics, a city scenery, etc.

In the specific embodiment, the processor may receive a request to change a background of specific slides in an online lecture video into ‘natural scenery’ from the user. In this case, the processor may search a background image corresponding to ‘natural scenery’ from the image conversion dataset, apply the corresponding image to a designated slide background of the first video content, and send back a changed video to the user terminal. Therefore, the user may watch a video including an updated background screen.

In addition, if the user additionally requests to change a background screen, when the user, for example, wants to change it into ‘city landscape’, the processor searches for a suitable ‘city landscape’ image within the image conversion dataset according to this request and applies it to an image, which process also is repeated whenever there is an additional request from the user. Each change is also reflected sequentially in an order requested by the user.

In this method, the processor may provide a visual experience which the user wants by variously changing a background screen of video contents and transmitting it to the user terminal according to the user's request.

According to an embodiment of the present disclosure, the processor may generate a second sound data to apply a first sound mastering preset corresponding to the first waveform information of a plurality of sound mastering presets previously stored, based on the first sound data, in the storage unit.

More specifically, according to the embodiment of the present disclosure, by analyzing the first sound data stored, the processor, among a plurality of predefined sound mastering presets, may identify the most appropriate sound mastering reset corresponding to characteristics of the first waveform information that criteria, such as a frequency response, a dynamic range, a timbre balance, etc. are considered.

In the specific embodiment, when the first sound data stored is a vocal-centered music track, the processor selects a preset to emphasize a vocal, reduce a background noise, and arrange a musical element in balance. For example, a ‘Vocal Emphasis’ preset emphasizes a mid-frequency band, removes a low-frequency noise by using a high-pass filter, and optimizes a vocal's dynamic range by applying multi-band compression.

Afterwards, the processor generates a second sound data by applying the ‘vocal emphasis’ preset selected to the first sound data, in which process, the processor applies an appropriate processing to each component of original sound data and all changes are reflected in the second sound data. The second sound data completed includes characteristics that a vocal clarity is improved, a sound balance is improved overall, and a background noise is reduced.

According to an embodiment of the present disclosure, the processor may transmit a first harmonic content that the second sound data is synchronized with the first video content to the user terminal.

More specifically, according to the embodiment of the present disclosure, the processor generates the first harmonic content that the second sound data is synchronized with the first video content, and then the processor transmits the first harmonic content to the user terminal through a network, and at this time, the first harmonic content transmitted is ready to be played on the user terminal.

In the specific embodiment, when a filmmaker requests a sound mastering for his or own short film, the processor performs a processing to improve an audio track of a dialogue, a music, a background noise, etc. in a movie, which includes a process to increase a clarity of voice and adjust a balance between the music and the background noise. When the processing is completed, the processor ensures that an improved soundtrack perfectly corresponds to each scene in video by synchronizing an improved audio track (second sound data) with an original video (first video content).

The synchronized harmonic content is transmitted to the user terminal, and the user may directly watch a movie including this improved audio quality on his or her own terminal, and a transmission to the user terminal may be achieved through data compression and optimization, and as a result, the user may enjoy content without quality loss while saving a download time.

According to an embodiment of the present disclosure, the processor, based on the first sound data and a first video data of the first video content, may identify a first video information including a conversation content, a natural environment, and a background sound included in the first video content.

More specifically, according to the embodiment of the present disclosure, the processor identifies a plurality of elements in the first video content through a digital analysis of video and audio data, and, at this time, a process of identification may be performed by utilizing an audio analysis algorithms and video data processing technology. The processor first distinguishes a conversation, a natural environment sound, a background noise, etc. from the first sound data, and, for this, technologies, such as a frequency analysis, a voice recognition technology, and sound characteristic mapping are utilized.

In the specific embodiment, when processing a video filmed in an urban environment, the processor distinguishes and classifies a vehicle movement, a conversation among people, a distant city noise, etc. The processor also analyzes the first video data to identify a scene that the conversation occurs, and importantly processes a sound data in the scene, so that it improves a clarity of the conversation. Additionally, when identifying a scene including natural environmental sounds, the processor adjusts an audio in a method of emphasizing a natural sound and minimizing a city noise.

Through such identification processes, the processor creates a sound profile suitable for the first video content, and, based on this, optimizes a sound processing. As a result, the user experiences a high-quality to audio properly adjusted characteristics of each scene, which improves overall a video viewing experience.

According to an embodiment of the present disclosure, the processor may display a plurality of purpose lists for production purpose of the first video content on the display unit in response to the first video information identified.

More specifically, according to the embodiment of the present disclosure, the processor, based on the first video information identified, displays a list of purposes to meet various production purposes that the first video content is intended to serve, on the user's display unit. In this process, the processor analyzes a content, a genre, a target audience, and the user's previous selection history, etc. of video content and makes up a list suitable for a production purpose.

In the specific embodiment, when processing a documentary video, the processor displays a list of purposes, such as ‘education’, ‘record’, ‘entertainment’, ‘public relations’, etc. on the display unit. The user, among these, may select one or more purposes best corresponding to her or his own video production purposes.

According to an embodiment of the present disclosure, when receiving a user input that a first purpose of a plurality of purpose lists from the user terminal is selected, the processor may identify sound data not corresponding to the first purpose of the first video information as a first noise, and generate a third sound data that the first noise is removed.

According to the embodiment of the present disclosure, after receiving information about the first purpose selected from the user terminal, the processor analyzes the first video information based on this. At this time, the processor identifies audio elements unrelated or disruptive to the first purpose, such as an unnecessary noise in the background, an inappropriate music, or a side conversation, etc., as the first noise.

In the specific embodiment, when receiving an input that a purpose of ‘education’ has been selected from the user, the processor classifies elements to reduce an educational value or interfere with a learning concentration, such as a sudden background sound and a music, a side conversation, etc. unrelated to educational content in the first video content, as the first noise. This classification process is automatically performed through a sound analysis algorithm.

Afterwards, the processor generates a third sound data not including the noise removed by performing an audio processing process that the first noise identified is removed, and this process may include a noise reduction technology, a frequency filtering, a dynamic range adjustment, etc. As a result, the processor generates the third sound data to provide an optimized audio environment which reveals an educational content more clearly and helps learners to concentrate.

According to an embodiment of the present disclosure, the processor sets a main frequency range in the third sound data and adjusts so that sound in the main frequency range is clear by adjusting EQ, and if the first purpose corresponds to an aspect that it is realized in a first space size predetermined, the processor allows an up-mix processing to be reflected in the third sound data, and if the first purpose corresponds to an aspect that it is realized in a size smaller than a second space size predetermined, the processor allows a downmix processing to be reflected in the third sound data.

According to the embodiment of the present disclosure, the processor, by processing the third sound data, sets the main frequency range so that a main audio element may be heard more clearly, and adjusts the EQ accordingly, and, in this process, the control unit allows important audio elements, such as a specific dialogue or a musical instrument, to be positioned in a key frequency band, and allows overall an audio quality to be improved by emphasizing this frequency band.

In the specific embodiment, when identifying an interview subject's voice as a main audio element in a video selected for a purpose of ‘interview’, the processor sets a frequency range that this voice mainly appears as a main frequency, and then, improves an understanding of conversation by increasing a clarity in the corresponding frequency range and reducing a background noise through adjusting the EQ.

In addition, the processor applies the up-mix and downmix processing in order to process audio space suitable for the first purpose. For example, when the first purpose is ‘performance’ and the first space size is set as a concert hall, the processor imitates a wider listening environment and reproduces an atmosphere of live performances including audience by applying the up-mix processing in the third sound data. Conversely, when the first purpose is ‘personal study’ and the second space size is set as a small personal study room, the processor provides a more focused, personalized listening environment by applying the downmix processing.

The third sound data processed in this way is finally transmitted to the user terminal, which enables a customized audio experience suitable to a purpose and a space setting selected by the user.

According to an embodiment of the present disclosure, the processor generates a fourth sound data that at least one of the up-mix processing or downmix processing is reflected in the third sound data, and may generate and transmit a second harmonic content that the fourth sound data is synchronized with the first video content to the user terminal.

In the specific embodiment, the processor according to the present disclosure applies the downmix processing to an audio track mainly composed of a voice and a simple background music when a video content for ‘podcast’ purpose is submitted by the user, which makes an audio a more immersive, personal listening experience and allows the user to focus more on a story. Conversely, the processor increases a stereoscopic effect of an environmental sound and music so that the user may feel as if she or he is at a performance venue by applying the up-mix processing to a video submitted for ‘live performance’ purposes.

The fourth sound data that the up-mix or downmix processing has been completed is precisely synchronized with the first video content, so that the second harmonic content is formed. Then, the processor transmits this completed second harmonic content to the user terminal, and when playing the second harmonic content transmitted on his or her own terminal, the user, depending on a selected purpose and space setting, will watch a video with an optimized audio, which allows the user to enjoy a more improved viewing experience.

According to an embodiment of the present disclosure, the processor may derive a correction constant for correcting the main frequency range in the third sound data by introducing the correction constant in [Equation 1] below.

$$K = {e}^{X / Y} + ( log Z ) - {W}^{2} + \sqrt{V} \qquad [ Equation 1 ]$$

In [Equation 1] above, K refers to the correction constant for the main frequency range, X refers to a strength of voice signal, Y refers to an intensity of background noise, a ratio of forms of X/Y refers to a specific aspect of audio data (e.g. energy or intensity ratio), e refers to a natural constant, an exponential response of these natural constants reflects playing a role as a sensitivity control for a correction of a main frequency range by allowing even small changes in a certain aspect of audio data to have a large impact, Z refers to a width of frequency band, and log(Z) converts this through logarithmic function, which enables a detailed control over a wider frequency range by generally reducing a scale for large values and giving a greater influence for small values. W refers to a volatility of audio signal and increases a stability of the audio signal in a correction process, by using a square of the volatility of the audio signal and applying a greater attenuation to a signal including high volatility. V represents a volume level or an energy level of audio, which is converted through a square root function, and a correction for overall audio signal strength is provided, which, in other words, plays a role that the correction for high volume levels may be applied more smoothly by using a square root.

For example, if audio data processed by the processor includes a voice content of a podcast video, the processor, in an initial analysis, identifies that voice in the audio data falls within a frequency range of 300 Hz to 3400 Hz which is consistent with a frequency range of typical human voice. The processor, by correcting a main frequency range in order to have a range equal to K in + and − to an original main frequency range through K of the correction constant derived through [Equation 1], also adjusts the main frequency range so that human voice, the main content of audio, may be heard more clearly and distinctly. Ultimately, the main frequency range adjusted in this method also allows the user to have a better audio experience by reducing an impact of background noise and contributing to increasing a voice clarity.

### EXPLANATION OF SYMBOLS

100: User Terminal
110: User Input Unit
120: Display unit
200: Server
210: Communication Unit
220: Storage unit
230: Processor

What is claimed is:

1. A harmonizing system for optimizing sound in content,
the system, comprising:
a user terminal configured to transmit and receive video content containing sound information, the user terminal including:
a display unit configured to display the video content;
a speaker configured to load the sound information and output sound; and
a user input unit configured for user input.

2. The harmonizing system according to claim 1,
further comprising:
a server network-connected to the user terminal, the server concluding:
a communication unit;
a storage unit; and
a processor configured:
to display at least one platform screen of a website that provides an execution of the artificial intelligence model or an application through a predetermined API, when receiving a request for a sound harmonization based on an artificial intelligence model from the user terminal,
to store a first sound data that includes the first waveform information in the storage unit by identifying a first waveform information that includes a frequency range and volume level based on a first sound information included in the first video content, when receiving a first video content of a plurality of video contents from the user terminal through the platform,
to generate a second sound data that applies a first sound mastering preset corresponding to the first waveform information of a plurality of sound mastering presets that are previously stored, based on the first sound data, in the storage unit, and
to transmit a first harmonic content that the second sound data is synchronized with the first video content to the user terminal.

3. The harmonizing system according to claim 2, wherein the processor is further configured:
to identify a first video information including conversation contents, natural environments, and background sounds, which are included in the first video content, based on the first sound data and a first video data of the first video content;
to display a plurality of purpose lists for production purposes of the first video content on the display unit, corresponding to the first video information identified;
to generate a third sound data that the first noise is removed and identify a sound data not corresponding to the first purpose of the first video information as a first noise, when receiving a user input that a first purpose of the plurality of purpose lists is selected from the user terminal;
to adjust a sound to be clear in the main frequency range by setting a main frequency range in the third sound data and adjusting EQ, allowing an up-mix processing to be reflected in the third sound data when the first purpose corresponds an aspect that it is realized in a first space size predetermined and allowing a downmix processing to be reflected in the third sound data when the first purpose corresponds an aspect that it is realized in a size smaller than a second space size predetermined; and
to transmit the second harmonic content to the user terminal by generating a fourth sound data that at least one of the up-mix processing or downmix processing is reflected in the third sound data and generating a second harmonic content that the fourth sound data is synchronized with the first video content.
